(19) United States
(12) Patent Application Publication
(10) Pub. No.: US 2024/0070532 A1
(43) Pub. Date: Feb. 29, 2024

(54) INTERNET OF THINGS (IOT) SENSOR BASED SYSTEMS AND METHODS FOR IMPROVING UTILIZATION OF A PHYSICAL DINING ENVIRONMENT USING ARTIFICIAL INTELLIGENCE

(71) Applicant: CEATZ INC., Chicago, IL (US)

(72) Inventor: Neil Misak, Libertyville, IL (US)

(21) Appl. No.: 18/156,281

(22) Filed: Jan. 18, 2023

Related U.S. Application Data
(60) Provisional application No. 63/401,247, filed on Aug. 26, 2022.

(51) Int. Cl. G06N 20/00; G06N 5/022

(52) U.S. Cl. CPC G06N 20/00; G06N 5/022

(57) ABSTRACT

Internet of Things (IoT) sensor based systems and methods of improving utilization of a physical dining environment using artificial intelligence (AI). The IoT sensor based systems and methods include collecting, by one or more processors, sensor data from one or more sensors positioned within the physical dining environment, where the sensor data corresponds to one or more locations within the physical dining environment; inputting, into an AI model executing on the one or more processors, the sensor data, where the AI model is trained with sensor data captured by the one or more sensors positioned within the physical dining environment; and generating, by the AI model and based on the sensor data, a prediction defining a utilization value of the physical dining environment.

### RELATED APPLICATION(S)

This application claims the benefit of U.S. Provisional Application No. 63/401,247 (filed on Aug. 26, 2022). The entirety of the foregoing provisional application is incorporated by reference herein.

### FIELD

The present disclosure generally relates to Internet of Things (IoT) sensor based systems and methods, and more particularly to IoT sensor based systems and methods for improving utilization of a physical dining environment using artificial intelligence (AI).

### BACKGROUND

Physical environments typically experience usage and foot traffic of users or patrons. However, such usage and foot traffic is difficult to analyze and track, especially for large and/or busy physical environments, such as physical dining environments. In such physical environments, there can be high amounts of activity at one period of time followed by a reduction of activity at another period of time. Traditional methods of tracking usage and foot traffic in a physical environment include manual data entry, where an employee associated with the physical environment manually enters information into a system, such as a point-of-sale (POS) system.

However, such manual entry is often inaccurate and fails to capture the activity of a given physical environment, such as a physical dining environment, where there are often various levels of activity at different points, and at different locations, in time. Such deficiencies often occur because there is a lack of digital or otherwise computerized mapping of the physical dining environment that can be used to track usage and foot traffic of users or patrons of the physical dining environment.

For the foregoing reasons, there is a need for IoT sensor based systems and methods for improving utilization of a physical dining environment using artificial intelligence (AI), as further described herein.

### SUMMARY

Generally, as described herein, Internet of Things (IoT) sensor based systems and methods are disclosed for improving utilization of a physical dining environment using artificial intelligence (AI). In various aspects, the IoT sensor based systems and methods provide a digital mapping of a real-world physical dining environment based on one or more sensors. The one or more sensors, e.g., alone, as a group, and/or together as a whole, can provide a digitized mapping based on a variety of sensor data types (e.g., including imaging, heat, communication, pressure, etc.) that can be used to track activity and otherwise users of a given physical dining environment. That is, from the sensor data, one or more AI models may be trained and then used to output a utilization valuation or prediction for, e.g., tracking and/or mapping the physical dining environment, including utilization thereof.

Generally, as described herein, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an IoT sensor based method of improving utilization of a physical dining environment using artificial intelligence (AI). The IoT sensor based method of improving utilization also includes collecting, by one or more processors, sensor data from one or more sensors positioned within the physical dining environment, where the sensor data corresponds to one or more locations within the physical dining environment. The IoT sensor based method of improving utilization also includes inputting, into an AI model executing on the one or more processors, the sensor data, where the AI model is trained with sensor data captured by the one or more sensors positioned within the physical dining environment. The IoT sensor based method of improving utilization also includes generating, by the AI model and based on the sensor data, a prediction defining a utilization value of the physical dining environment. Other embodiments of this aspect include corresponding computer systems, apparatus, and computer programs recorded on one or more computer storage devices, each configured to perform the actions of the methods.

Implementations of the disclosed method may include one or more of the following features. The IoT sensor based method may comprise where the AI model is further trained with timing data, where generating the prediction further includes inputting a time value for the prediction, and where the prediction defines the utilization value for the physical dining environment at the time value. The sensor data may correspond to a portion of the physical dining environment, and where the prediction defining the utilization of the physical dining environment is an extrapolated prediction based on the portion of the physical dining environment. The AI model may further be trained with one or more of: weather data, event data, traffic data, a number of tables or seats within the physical dining environment, non-sensor based occupancy data defining occupancy within the physical dining environment, one or more meal duration times, customer-specific data, a type of table or seat within the physical dining environment, and/or historical transactions made by customers of the physical dining environment. The AI model may be further trained with infrastructure related data of the physical dining environment. The one or more sensors include one or more of: one or more pressure sensors, one or more imaging sensors, one or more heat sensors, and/or one or more signal sensors The one or more sensors including an existing camera configured to capture images of users within the physical dining environment. The one or more locations areas of the physical dining environment include one or more of: a seat positioned within the physical dining environment, a table positioned within the physical dining environment, or a bar area positioned within the physical dining environment. The prediction corresponds to a specific location within the physical dining environment. The IoT sensor based method further including determining a one or more outputs based on the prediction, the one or more outputs including of at least one of: a service provided by an operator of the physical dining environment, a value of a food item provided by the operator of the physical dining environment, a value of a reservation provided by an operator of the physical dining environment, and/or a dynamic menu offered by the operator of the physical dining environment. The one or more outputs includes a ranged value. The utilization value may be generated in real time or near-real time. Additionally, or alternatively, an indication of the utilization value ca be displayed on a graphic user interface (GUI) on periodic basis (e.g., in real time or near-real time). Implementations of the described techniques may include hardware, a method or process, or computer software on a computer-accessible medium.

Another general aspect includes an IoT sensor based system configured to improve utilization of a physical dining environment using artificial intelligence (AI). The IoT sensor based system also includes one or more sensors positioned within a physical dining environment. The IoT sensor based system also includes one or more processors communicatively coupled to the one or more sensors. The IoT sensor based system also includes one or more memories accessible by the one or more processors. The IoT sensor based system also includes computing instructions stored on the one or more memories that, when executed, cause the one or more processors to: collect sensor data from the one or more sensors positioned within the physical dining environment, where the sensor data corresponds to one or more locations within the physical dining environment; input, into an AI model executing on the one or more processors, the sensor data, where the AI model may be trained with sensor data captured by the one or more sensors positioned within the physical dining environment; and generate, by the AI model and based on the sensor data, a prediction defining a utilization value of the physical dining environment. Other aspects of the disclosed system include corresponding computer systems, apparatus, and computer programs recorded on one or more computer storage devices, each configured to perform the actions of the methods.

Implementations of the disclosed system may include one or more of the following features. The IoT sensor based system where the AI model may be further trained with timing data, where generating the prediction further includes inputting a time value for the prediction, and where the prediction defines the utilization value for the physical dining environment at the time value. The sensor data corresponds to a portion of the physical dining environment, and where the prediction defining the utilization of the physical dining environment may be an extrapolated prediction based on the portion of the physical dining environment. The AI model may be further trained with one or more of: weather data, event data, traffic data, a number of tables or seats within the physical dining environment, non-sensor based occupancy data defining occupancy within the physical dining environment, one or more meal duration times, customer-specific data, a type of table or seat within the physical dining environment, and/or historical transactions made by customers of the physical dining environment. The AI model may be further trained with infrastructure related data of the physical dining environment. The one or more sensors include one or more of: one or more pressure sensors, one or more imaging sensors, one or more heat sensors, and/or one or more signal sensors The one or more sensors including an existing camera configured to capture images of users within the physical dining environment. Other aspects may include those described by the method(s) herein. Still further, implementations of the described system may include hardware, a method or process, or computer software on a computer-accessible medium.

A still further general aspect includes a tangible, non-transitory computer-readable medium storing instructions for improving utilization of a physical dining environment using artificial intelligence (AI). The instructions, when executed by one or more processors, may cause the one or more processors to: collect sensor data from one or more sensors positioned within the physical dining environment, where the sensor data corresponds to one or more locations within the physical dining environment. The instructions, when executed by one or more processors, may further cause the one or more processors to input, into an AI model executing on the one or more processors, the sensor data, where the AI model may be trained with sensor data captured by the one or more sensors positioned within the physical dining environment. The instructions, when executed by one or more processors, may further cause the one or more processors to generate, by the AI model and based on the sensor data, a prediction defining a utilization value of the physical dining environment. Other aspects of the tangible, non-transitory computer-readable medium storing instructions may include corresponding computer systems, apparatus, and computer programs recorded on one or more computer storage devices, each configured to perform the actions of the methods.

The present disclosure relates to improvements to other technologies or technical fields at least because the present disclosure describes or introduces improvements to computing devices in the field of sensor analytics, whereby the internet of things (IoT) sensor based systems and methods execute, at least partially, in a physical environment utilizing one or more sensors positioned therein with digital based analysis of sensor data to digitally map a physical environment and implementing enhanced artificial intelligence (AI) predictions based on the digital mapping in order to determine utilization thereof. Such systems and methods are configured to operate using a reduced processing and/or memory (e.g., a reduced set of data compared to a full amount of data collected by sensors, such as IoT sensors), and thus can operate on limited compute and memory devices, including mobile devices. Such reduction frees up the computational resources of an underlying computing system, thereby making it more efficient.

Still further, the present disclosure relates to improvement to other technologies or technical fields at least because the present disclosure describes or introduces improvements to computing devices in the field of security and/or sensor data processing, where, at least in some aspects, sensor data of users (e.g., images, heat data, and/or pressure data of users) may be analyzed or collected, and in some instances preprocessed (e.g., cropped, blurred, obscured or otherwise modified), to define extracted or depicted regions of an individual without depicting personal identifiable information (PII) of the individual. For example, head portion or outline (or pressure data) of an individual may be digitally redacted, or in some aspects, the digital image by be blurred or otherwise obscured, at least with respect to certain areas, such as facial or other PII areas. Additionally, or alternatively, simple cropped or redacted portions of an image may be used, which eliminates the need of transmission of images of individuals or portions of individuals across a computer network (where such images may be susceptible of interception by third parties). Such features provide a security improvement, i.e., where the removal of PII (e.g., private area features) provides an improvement over prior systems because cropped or redacted images, especially ones that may be transmitted over a network (e.g., the Internet), are more secure without including PII information of an individual. That is, the tracking of activity within a physical environment need not use PII data of an individuals. Accordingly, the systems and methods described herein operate without the need for such essential information, which provides an improvement, e.g., a security improvement, over prior systems. In addition, the use of cropped, modified, or obscured images, at least in some aspects, allows the underlying system to store and/or process smaller data size images, which results in a performance increase to the underlying system as a whole because the smaller data size images require less storage memory and/or processing resources to store, process, and/or otherwise manipulate by the underlying computer system. For example, the AI model described herein can operate on reduced and/or redacted PII information, and, therefore, can reduce the memory and/or processing utilization of the system as a whole.

The present disclosure includes application, or by use of, a particular machine, e.g., environment sensors, such as imaging, pressure, and/or heat sensors, in order to generate or otherwise determine a mapping of a physical environment, e.g., a physical dining environment.

The present disclosure includes effecting a transformation or reduction of a particular article to a different state or thing, e.g., generating sensor data to transform or reduce the sensor data into a digital mapping of a physical environment, e.g., a physical dining environment, in order to generate or otherwise determine a utilization value of the physical environment, e.g., the physical dining environment.

In addition, the present disclosure includes specific features other than what is well-understood, routine, conventional activity in the field, and that add unconventional steps that confine the claim to a particular useful application, e.g., internet of things (IoT) sensor based systems and methods for improving utilization of a physical dining environment using artificial intelligence (AI).

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements and instrumentalities shown, wherein:

FIG. 1 illustrates an example IoT sensor based system configured to improve utilization of a physical dining environment using artificial intelligence (AI), in accordance with various aspects disclosed herein.

FIG. 2 illustrates an example physical dining environment with one or more sensors, in accordance with various aspects disclosed herein.

FIG. 3 illustrates an example IoT sensor based method of improving utilization of a physical dining environment using artificial intelligence (AI), in accordance with various aspects disclosed herein.

FIG. 4 illustrates an example user interface as rendered on a display screen of a user computing device in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION OF THE INVENTION

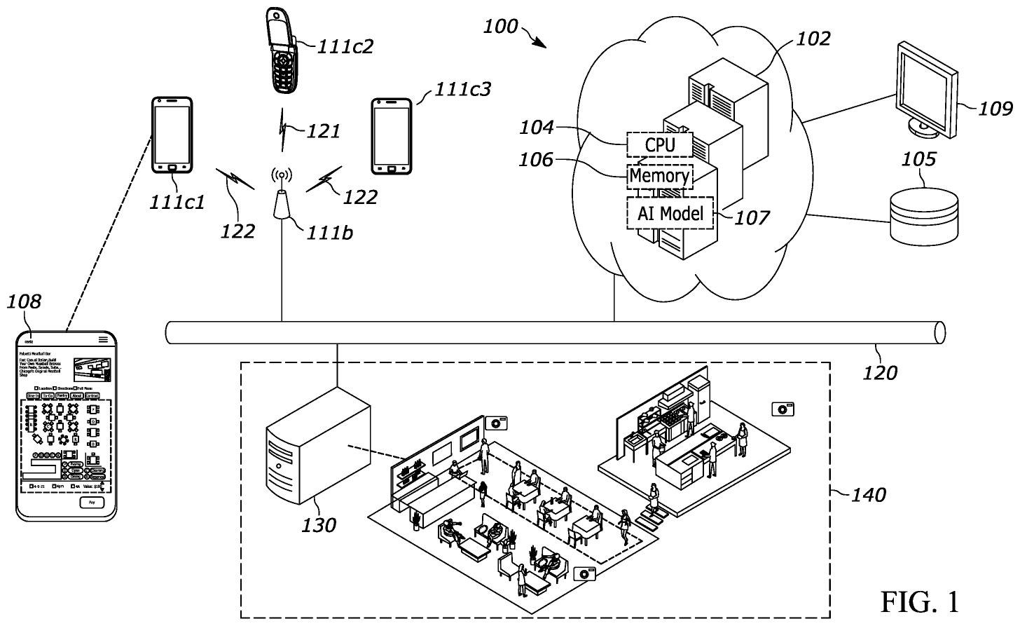

FIG. 1 illustrates an example IoT sensor based system 100 configured to improve utilization of a physical dining environment using artificial intelligence (AI), in accordance with various aspects disclosed herein. In the example aspect of FIG. 1, IoT sensor based system 100 includes server(s) 102, which may comprise one or more computer servers. In various aspects server(s) 102 comprise multiple servers, which may comprise multiple, redundant, or replicated servers as part of a server farm. In still further aspects, server(s) 102 may be implemented as cloud-based servers, such as a cloud-based computing platform. For example, IoT server(s) 102 may be any one or more cloud-based platform(s) such as MICROSOFT AZURE, AMAZON AWS, or the like. Server(s) 102 may include one or more processor(s) 104 as well as one or more computer memories 106. In various aspects, server(s) 102 may be referred to herein as “IoT server(s).”

Memories 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 106 may store an operating system (OS) (e.g., Microsoft Windows, Linux, UNIX, etc.) capable of facilitating the functionalities, apps, methods, or other software as discussed herein. Memorie(s) 106 may also store an artificial intelligence (AI) model 107, which may comprise or may be configured to access an artificial intelligence based model, such as a machine learning model, trained on sensor data, as described herein. Additionally, or alternatively, sensor data (e.g., which in some aspects, may serve as training sensor data), such as sensor data from any one or more of sensors 142a, 142b, 142c, may also be stored in database 105, which is accessible or otherwise communicatively coupled to IoT server(s) 102. In addition, memories 106 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. It should be appreciated that one or more other applications may be envisioned and that are executed by the processor(s) 104.

The processor(s) 104 may be connected to the memories 106 via a computer bus responsible for transmitting electronic data, data packets, or otherwise electronic signals to and from the processor(s) 104 and memories 106 in order to implement or perform the machine readable instructions, methods, processes, elements or limitations, as illustrated, depicted, or described for the various flowcharts, illustrations, diagrams, figures, and/or other disclosure herein.

Processor(s) 104 may interface with memory 106 via the computer bus to execute an operating system (OS). Processor(s) 104 may also interface with the memory 106 via the computer bus to create, read, update, delete, or otherwise access or interact with the data stored in memories 106 and/or the database 105 (e.g., a relational database, such as Oracle, DB2, MySQL, or a NoSQL based database, such as MongoDB). The data stored in memories 106 and/or database 105 may include all or part of any of the data or information described herein, including, for example, digital images, which may be used as training data (e.g., including sensor data) and/or other images and/or information of regarding a physical dining environment, or as otherwise described herein.

IoT server(s) 102 may further include a communication component configured to communicate (e.g., send and receive) data via one or more external/network port(s) to one or more networks or local terminals, such as computer network 120 and/or terminal 109 (for rendering or visualizing) described herein. In some aspects, IoT server(s) 102 may include a client-server platform technology such as ASP.NET, Java J2EE, Ruby on Rails, Node.js, a web service or online API, responsive for receiving and responding to electronic requests. The IoT server(s) 102 may implement the client-server platform technology that may interact, via the computer bus, with the memories(s) 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

In various aspects, the IoT server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some aspects, computer network 120 may comprise a private network or local area network (LAN). Additionally, or alternatively, computer network 120 may comprise a public network such as the Internet.

IoT server(s) 102 may further include or implement an operator interface configured to present information to an administrator or operator and/or receive inputs from the administrator or operator. As shown in FIG. 1, an operator interface may provide a display screen (e.g., via terminal 109). IoT server(s) 102 may also provide I/O components (e.g., ports, capacitive or resistive touch sensitive input panels, keys, buttons, lights, LEDs), which may be directly accessible via, or attached to, IoT server(s) 102 or may be indirectly accessible via or attached to terminal 109. According to some aspects, an administrator or operator may access the server 102 via terminal 109 to review information, make changes, input training data and/or images, initiate training of an AI model (e.g., as AI model 107), and/or perform other functions as described herein.

In some aspects, IoT server(s) 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

As shown in FIG. 1, IoT server(s) 102 are communicatively connected, via computer network 120 to the one or more user computing devices 111c1-111c3 via base station 111b. In some aspects, base station 111b may comprise a cellular base station, such as cell towers, communicating to the one or more user computing devices 111c1-111c3 via wireless communications 121 based on any one or more of various mobile phone standards, including NMT, GSM, CDMA, UMMTS, LTE, 5G, or the like. Additionally, or alternatively, base station 111b may comprise a router, wireless switch, or other such wireless connection points communicating to the one or more user computing devices 111c1-111c3 via wireless communications 122 based on any one or more of various wireless standards, including by non-limiting example, IEEE 802.11a/b/c/g (WIFI), the BLUETOOTH standard, or the like.

Any of the one or more user computing devices 111c1-111c3 may comprise mobile devices and/or client devices for accessing and/or communications with IoT server(s) 102. Such mobile devices may comprise one or more mobile processor(s) and/or an imaging device for capturing images. In various aspects, user computing devices 111c1-111c3 may comprise a mobile phone (e.g., a cellular phone), a tablet device, a personal data assistance (PDA), or the like, including, by non-limiting example, an APPLE iPhone or iPad device or a GOOGLE ANDROID based mobile phone or tablet.

In various aspects, the one or more user computing devices 111c1-111c3 may implement or execute an operating system (OS) or mobile platform such as APPLE iOS and/or Google ANDROID operation system. Any of the one or more user computing devices 111c1-111c3 may comprise one or more processors and/or one or more memories for storing, implementing, or executing computing instructions or code, e.g., a mobile application, as described in various aspects herein. As shown in FIG. 1, mobile app 108 as described herein, or at least portions thereof, may also be stored locally on a memory of a user computing device (e.g., user computing device 111c1).

User computing devices 111c1-111c3 may comprise a wireless transceiver to receive and transmit wireless communications 121 and/or 122 to and from base station 111b. In various aspects, information or data (e.g., output, prediction, utilization values, value(s) of food item(s)/reservation(s), menus, seating charts, digital mapping, and/or related graphics, or otherwise) may be transmitted via computer network 120 to and from IoT server(s) 102 to a user computing device (e.g., user computing device 111c1) for analysis and or provision as described herein.

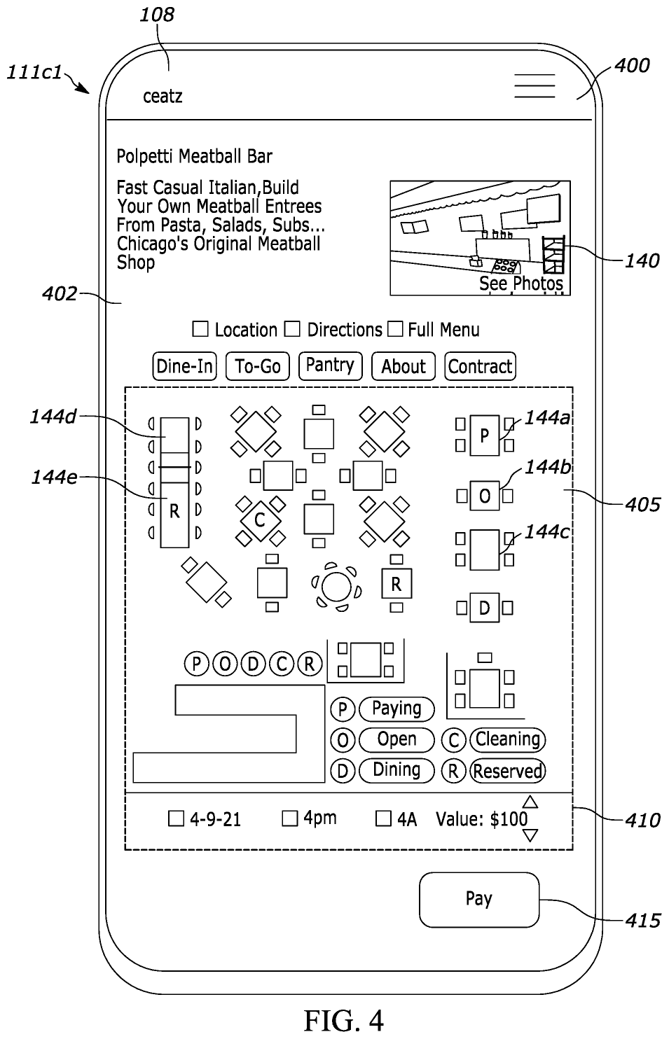

A user computer device (e.g., user computing device 111c1) may comprise, implement, have access to, render, or otherwise expose, at least in part, an interface or a guided user interface (GUI) for displaying text and/or images on its display screen. In various aspects, a display screen (e.g., display screen 400 as described for FIG. 4 herein) can also be used for providing or displaying information, and/or instructions or guidance to the user of a given device (e.g., user computing device 111c1). For example, each of the one or more user computer devices 111c1-111c3 may include a display screen for displaying graphics, images, data, pixels, features, and/or other such visualizations or information (e.g., an image of a physical dining environment 140, a digital mapping 405, or otherwise seating or location chart, of physical dining environment 140, a value of a reservation 410 provided by an operator of the physical dining environment, etc.) as described herein.

Physical dining environment 140 may be a physical environment of a restaurant or otherwise store or area having one or more locations within the physical dining environment 140. The one or more locations may comprise, by way of non-limiting example, chairs, seats, tables, bar areas, or otherwise locations, positions, and/or areas that may be occupied by a user or otherwise occupant of the physical dining environment 140.

The physical dining environment 140 can have positioned therein one or more sensors (e.g., one or more sensors 142a, 142b, 142c, such as imaging sensors) configured to capture sensor data of the physical dining environment 140. The one or more sensors may be communicatively coupled to a computing device 130 (e.g., a server or computer) situated in or in a proximity to physical dining environment 140. The computing device 130 can collect or capture sensor data of the physical dining environment 140 and transmit the sensor data to server(s) 102. The sensor data may be used to train AI model 107. Additionally, or alternatively, the sensor data may be used as input into a trained AI model 107 to provide an output, e.g., a prediction defining a utilization value of the physical dining environment 140.

The sensor data received at computing device 130 and/or server(s) 102 may be based on the sensor that generated such data. For example, the data may include two-dimensional (2D) sensor data (e.g., 2D images having pixel data). Additionally, or alternatively, the data may include three-dimensional (3D) data such as LiDAR data time-of-flight (ToF) data. Additionally, or alternatively, the data may include heat data of one or more individuals in the physical dining environment 140. Additionally, or alternatively, the data may include pressure data (e.g., pressure derived from one or more individuals sitting on a chair or seat within the physical dining environment 140). Additionally, or alternatively, the data may include signal derived from mobile devices of one or more individuals within the physical dining environment 140).

In some aspects, computing instructions and/or applications executing at the server (e.g., server(s) 102) may be communicatively connected to receive and/or analyzing such sensor data in order to train AI model 107 and/or provide outputs and/or predictions from an already trained AI model 107, as described herein. For example, sensor data may be used for analysis, output, and/or training or implementing model(s), such as AI or machine learning models, as described herein. In various sensor data be received at IoT server(s) 102, analysis and output (e.g., predictions and/or utilization values) may be determined, and output or related information may be transmitted for display on the display screen of any one or more of user computer devices 111c1-111c3.

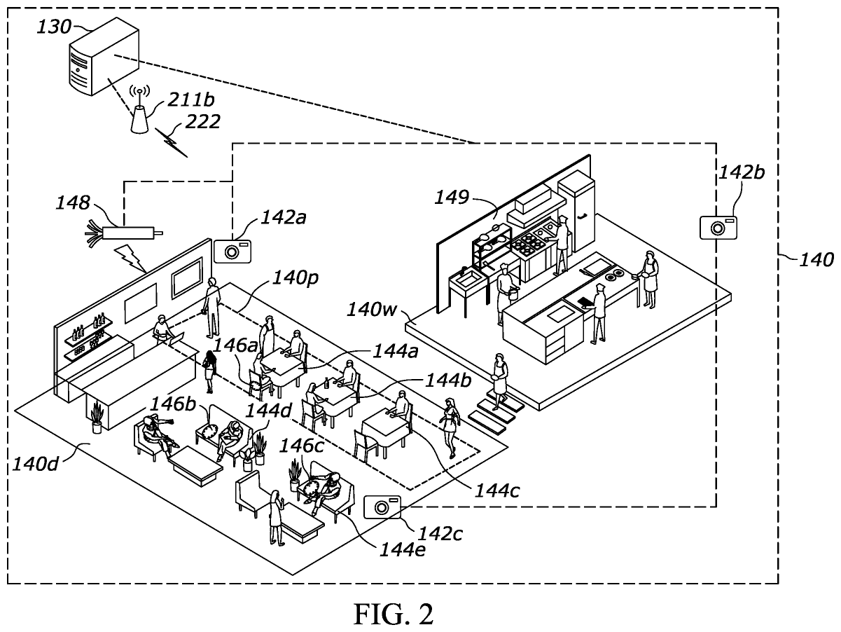

FIG. 2 illustrates an example physical dining environment 140 with one or more sensors (e.g., sensors 142a, 142b, 142c, 146a, 146b, 146c 148), in accordance with various aspects disclosed herein. As shown for FIG. 2, the physical dining environment 140 may comprise a dining area 140d where users, patrons, diners, or otherwise occupants may reside. The physical dining environment 140 may comprise one or more portions, such as a portion of the physical dining environment 140p, which may be monitored or digitally mapped separately from other portions of physical dining environment 140. In addition, physical dining environment 140 comprises one or more locations (e.g., locations 144a, 144b, 144c, 144d, 144e), which can comprise one or more of a seat positioned within the physical dining environment, a table positioned within the physical dining environment, or a bar area positioned within the physical dining environment. Some locations are specific, such as a specific position or point (e.g., of a seat, chair, table, or geographic area) within the physical dining environment 140. Additionally, or attentively, additional and/or different locations, areas, or types of locations and/or areas are contemplated herein.

In addition, physical dining environment 140 may comprise a work area 140w where workers (e.g., chefs or employees) may reside and may have access to infrastructure 149 (e.g., grills, ovens, stoves, cookware, or other machines or assets used to prepare food, beverages, and/or other items) provided by or associated with the physical dining environment 140.

As shown for FIG. 2, and as described for FIG. 1, physical dining environment 140 may comprise a computing device 130 (e.g., a server). The computing device 130 can be communicatively coupled to one or more sensors (e.g., any one or more of sensors 142a, 142b, 142c, 146a, 146b, 146c and/or 148) positioned within or otherwise located in a proximity to physical dining environment 140. The sensors one or more sensors (e.g., any one or more of sensors 142a, 142b, 142c, 146a, 146b, 146c, and/or 148) may be communicatively coupled to computing device 130 via a physical wired connection (e.g., a local area network (LAN)) of the physical dining environment 140, for example, as shown for sensors 142a, 142b, 142c, and 148. Additionally, or alternatively, any of the one or more sensors may be communicatively coupled to computing device 130 wirelessly (e.g., via the WIFI standard and/or BLUETOOTH standard), where computing device 130 sends wireless signals (e.g., wireless signal 222) via base station 211b to receive and communicate wireless data to various sensors, such as sensors 146a, 146b, and 146c. It is to be understood that that FIG. 2 shows an example of sensor positioning and communication types, and that different and/or additional configurations, including different sensor positioning and/or wired or wireless communication may be used or configured for each sensor.

In some examples, the sensors may include, by way of non-limiting example, sensors 142a, 142b, 142c, which may comprise one or more imaging sensors, such as cameras for capturing two dimensional (2D) and/or three-dimensional (3D) images. For example, in various aspects, the digital image(s) captured by sensors 142a, 142b, 142c may comprise various data types and/or formats as captured by 3D imaging capture systems or cameras, including, by way of non-limiting example, light-detecting-and-ranging (LiDAR) based digital images, time-of-flight (ToF) based digital images, other similar types of images as captured by imaging capture systems and/or cameras. For example, ToF based digital images, and/or related data, are determined from using a reference speed, e.g., the speed of light (or sound), to determine distance. ToF measures the time it takes for light (or sound) to leave a sensor, bounce off an object, plane, and/or surface (e.g., an individual), and return to the sensor. Such time measurement can be used to determine the distance from the device to the object, plane, and/or surface. Such information can then be used to construct a 3D model of the image captured. More generally, LiDAR is a specific implementation of ToF that uses light and the speed of light for distance determination and 3D image determination. Generally, LiDAR specific implementation uses pulsed lasers to build a point cloud, which may then be used to construct a 3D map or image. Compared to LiDAR, typical implementations of ToF image analysis involves a similar, but different, creation “depth maps” based on light detection, usually through a standard RGB camera. With respect to the disclosure herein, LiDAR, ToF, and/or other 3D imaging techniques are compatible, and may each, together or alone, be used with, the disclosure and/or aspects herein. In various aspects, such digital images may be saved or stored in formats, including, but not limited to, e.g., JPG, TIFF, GIF, BMP, PNG, and/or other files, data types, and/or formats for saving or storing such images.

Additionally or alternatively, in various aspects, digital image(s) captured by sensors 142a, 142b, 142c may comprise various data types and/or formats as captured by various 2D imaging capture systems or cameras. Such digital images may comprise color and/or channel data, including by way of non-limiting example, red-green-blue (RGB) data, CIELAB (LAB) data, hue saturation value (HSV) data, and/or or other color formats and/channels. Such digital images may be transmitted to, captured, stored, processed, analyzed, and/or otherwise manipulated and used as described herein, by IoT sensor based system 100.

In addition, in various aspects, each of the digital images (e.g., as captured by sensors 142a, 142b, 142c) may comprise pixel data (e.g., RGB data) comprising feature data and corresponding to one or more image features, within the respective image. The pixel data may be captured by a sensor of physical dining environment 140. For example, with respect to digital images as described herein, pixel data (e.g., pixel data of the sensor based images) may comprise individual points or squares of data within an image, where each point or square represents a single pixel within an image. Each pixel may be at a specific location within an image. In addition, each pixel may have a specific color (or lack thereof). Pixel color, may be determined by a color format and related channel data associated with a given pixel. For example, a popular color format is a 1976 CIELAB (also referenced herein as the “CIE L*-a*-b*” or simply “L*a*b*” or “LAB” color format) color format that is configured to mimic the human perception of color. Namely, the L*a*b* color format is designed such that the amount of numerical change in the three values representing the L*a*b* color format (e.g., L*, a*, and b*) corresponds roughly to the same amount of visually perceived change by a human. This color format is advantageous, for example, because the L*a*b* gamut (e.g., the complete subset of colors included as part of the color format) includes both the gamuts of Red (R), Green (G), and Blue (B) (collectively RGB) and Cyan (C), Magenta (M), Yellow (Y), and Black (K) (collectively CMYK) color formats.

In the L*a*b* color format, color is viewed as point in three dimensional space, as defined by the three-dimensional coordinate system (L*, a*, b*), where each of the L* data, the a* data, and the b* data may correspond to individual color channels, and may therefore be referenced as channel data. In this three-dimensional coordinate system, the L* axis describes the brightness (luminance) of the color with values from 0 (black) to 100 (white). The a* axis describes the green or red ratio of a color with positive a* values (+a*) indicating red hue and negative a* values (−a*) indicating green hue. The b* axis describes the blue or yellow ratio of a color with positive b* values (+b*) indicating yellow hue and negative b* values (−b*) indicating blue hue. Generally, the values corresponding to the a* and b* axes may be unbounded, such that the a* and b* axes may include any suitable numerical values to express the axis boundaries. However, the a* and b* axes may typically include lower and upper boundaries that range from approximately 150 to −150. Thus, in this manner, each pixel color value may be represented as a three-tuple of the L*, a*, and b* values to create a final color for a given pixel.

As another example, an additional or alternative color format includes the red-green-blue (RGB) format having red, green, and blue channels. That is, in the RGB format, data of a pixel is represented by three numerical RGB components (Red, Green, Blue), that may be referred to as a channel data, to manipulate the color of pixel's area within the image. In some implementations, the three RGB components may be represented as three 8-bit numbers for each pixel. Three 8-bit bytes (one byte for each of RGB) may be used to generate 24-bit color. Each 8-bit RGB component can have 256 possible values, ranging from 0 to 255 (i.e., in the base 2 binary system, an 8-bit byte can contain one of 256 numeric values ranging from 0 to 255). This channel data (R, G, and B) can be assigned a value from 0 to 255 that can be used to set the pixel's color. For example, three values like (250, 165, 0), meaning (Red=250, Green=165, Blue=0), can denote one Orange pixel. As a further example, (Red=255, Green=255, Blue=0) means Red and Green, each fully saturated (255 is as bright as 8 bits can be), with no Blue (zero), with the resulting color being Yellow. As a still further example, the color black has an RGB value of (Red=0, Green=0, Blue=0) and white has an RGB value of (Red=255, Green=255, Blue=255). Gray has the property of having equal or similar RGB values, for example, (Red=220, Green=220, Blue=220) is a light gray (near white), and (Red=40, Green=40, Blue=40) is a dark gray (near black).

In this way, the composite of three RGB values creates a final color for a given pixel. With a 24-bit RGB color image, using 3 bytes to define a color, there can be 256 shades of red, and 256 shades of green, and 256 shades of blue. This provides 256×256×256, i.e., 16.7 million possible combinations or colors for 24 bit RGB color images. As such, a pixel's RGB data value indicates a degree of color or light each of a Red, a Green, and a Blue pixel is comprised of. The three colors, and their intensity levels, are combined at that image pixel, i.e., at that pixel location on a display screen, to illuminate a display screen at that location with that color. In is to be understood, however, that other bit sizes, having fewer or more bits, e.g., 10-bits, may be used to result in fewer or more overall colors and ranges. Further, it is to be understood that the pixel data may contain additional or alternative color format and channel data. For example, the pixel data may include color data expressed in a hue saturation value (HSV) format or hue saturation lightness (HSL) format.

As a whole, the various pixels, positioned together in a grid pattern (e.g., comprising pixel data), form a digital image or portion thereof. A single digital image can comprise thousands or millions of pixels or channels. Images can be captured, generated, stored, and/or transmitted in a number of formats, such as JPEG, TIFF, PNG and GIF. These formats use pixels to store or represent the image.

With reference to FIG. 2, each of digital images (e.g., as captured by sensors 142a, 142b, and/or 142c) can depict a frame or image of physical dining environment 140 (or portion thereof), including any seats, tables, or bar areas positioned therein (e.g., such as locations 144a, 144b, 144c, 144d, 144e). The locations can either have or do not have a presence of a user or occupant that is occupying the location. In this way, where the sensor data comprises image data, such analysis can be determined from the pixel data, where each of the images may comprise a plurality of pixels. The pixel data, and features thereof, may define human features, such as facial features, head, neck, body, etc. that may be used to determine whether a given location is occupied. For example, pixels may define features determined from or otherwise based on one or more pixels in a digital image. For example, each image comprise or be part of a pixel set or group of pixels depicting, or otherwise indicating facial or head features, where each pixel comprises a darker pixel color (e.g., pixels with relatively low L* values and/or pixels with lower RGB values) that are indicative of given feature(s) of the image such as eyes, nose, mouth, or hair, or head. For example, groups of pixels can represent features of the image. That is, in a specific example, an edge of an individual's body may be determined by an abrupt change in RGB values indicating that the neighboring pixels belong to two different surfaces. A collection of surface edges can be used to determine a body outline, and the position of those edges relative to other parts of the body can be used to determine which body part has been located.

Additionally, or alternatively, various other pixels including remaining portions of an occupant may define an individual's position, posture, etc., which may be analyzed as described herein, for example, for analysis and/or used for training of AI model(s), and/or analysis by already trained models. For example, pixel data of digital images may be used to determine how many occupants are in physical dining environment 140 which can then be used to determine utilization value(s) of physical dining environment 140, or otherwise as described herein.

Additionally, or alternatively, one or more sensors 142a, 142b, 142c may comprise one or more heat sensors. The heat sensors may be configured for capturing heat emitted by human occupants within physical dining environment 140. The heat sensors can detect heat, such as via thermal imaging, at one or more locations within the physical environment 140, such as one or more locations 144a, 144b, 144c, 144d, and/or 144e.

Still further, additionally or alternatively, sensors of physical environment 140 may also comprise one or more pressure sensors 146a, 146b, and/or 146c that may be positioned in seats or other sitting and/or standing locations within physical environment 140. The pressure sensors can detect pressure, such as via weight, of a user sitting or standing at one or more locations within the physical environment 140, such as one or more locations 144a, 144d, and/or 144e.

Still further, additionally or alternatively, physical environment 140 may have one or more signal sensor(s), such as signal sensor 148. Signal sensor, shown as a multiplexed signal sensor, can capture signals being transmitted within, into, and/or out of physical dining environment 140, including at one or more locations within the physical environment 140, such as one or more locations 144a, 144b, 144c, 144d, and/or 144e. In particular, the signals can be detected emitting from and/or traveling to, or in a proximity of, the one or more locations such as one or more locations 144a, 144b, 144c, 144d, and/or 144e.

In various aspects the sensor data (e.g., 2D and/or 3D digital images, heat or thermal data, pressure data, and/or signal data) may be transmitted to computing device 130 and/or server(s) 102, where, for example, the sensor data is captured at computing device 130 and then communicated to server(s) 102 via computer network 120. In various aspects, sensor data may be collected or aggregated at IoT server(s) 102 and may be used for analysis as described herein. In addition, in some aspects, such sensor data may be used to implement and/or train an artificial intelligence learning model (e.g., AI model 107), which may comprise a machine learning imaging model as described herein). Such AI models may be used for outputting a prediction or utilization value, or related information, or the like, for example, as described herein.

In various aspects, sensor data may be or may comprise redacted, reduced, cropped or otherwise obscured sensor data. For example, with respect to image data, a cropped or obscured image is an image with one or more pixels removed, deleted, hidden, or blurred, or otherwise altered from an originally captured image. For example, an original image may be modified to be blurred or hidden to remove, hide, or obscure portions of the individual (e.g., a face of an occupant of physical environment) such that a related image may not include personally identifiable information (PII). Additionally, thermal data and/or pressure can be used which does not include any PII and/or would not be added to such data. Still further, signal data can be captured to remove or avoid any PII information, such as a user's phone number or related mobile device information.

In various aspects, server(s) 102 analyzing and/or use of redacted, reduced, cropped or otherwise obscured sensor data for training can improve the efficiency and performance of the underlying computer system in that the underlying system processes, stores, and/or transfers smaller size data. In addition, such features provide a security improvement, i.e., where the removal of PII provides an improvement over prior systems because redacted, reduced, cropped or otherwise obscured sensor data, especially data that may be transmitted over a network (e.g., the Internet), is more secure without including PII information of a given individual. Importantly, the systems and methods described herein may operate without the need for such non-essential information, which provides an improvement, e.g., a security and a performance improvement, over conventional systems.

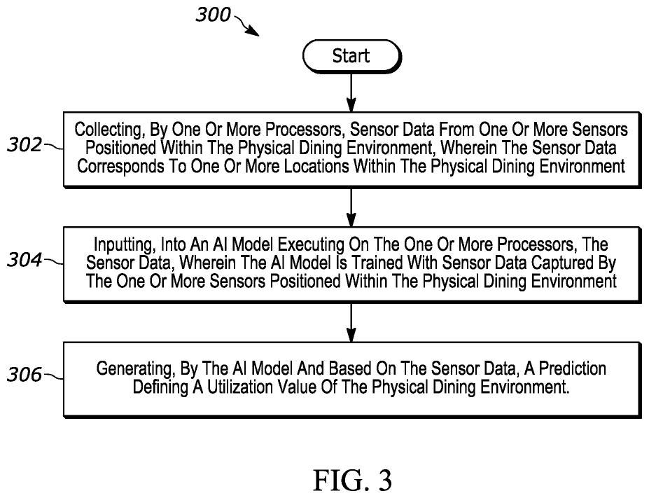

FIG. 3 illustrates an example IoT sensor based method 300 of improving utilization of a physical dining environment using artificial intelligence (AI), in accordance with various aspects disclosed herein. Method 300 may comprise computing instructions or otherwise an algorithm implemented by processor(s) 104 of server(s) 102 and/or computing device 130, for example, as described for FIG. 1 herein.

With reference to FIG. 3, at block 302, method 300 comprises collecting, by one or more processors (e.g., processors 104), sensor data from one or more sensors (e.g., any one or more of sensors 142a, 142b, 142c, 146a, 146b, 146c, and/or 148) positioned within the physical dining environment. In various aspects, the one or more sensors may comprise one or more pressure sensors. Such pressure sensor(s), for example, any one or more of pressure sensors 146a, 146b, and/or 146c, may be positioned within or otherwise a proximity to seats, chairs, or other locations within the physical dining environment 140. Such pressure sensor(s) may measure and/or collect sensor data indicating pressure at a given chair, seat, table, or otherwise a location of the physical dining environment 140. In some aspects, the pressure data may define a weight or degree of contact between a surface (e.g., a chair or bar seat surface, e.g., at any one or more of locations 144a, 144b, 144c, 144d, and/or 144e) and may be used to detect whether a given location (e.g., a chair) is occupied by a person or not.

Additionally, or alternatively, the one or more sensors may comprise one or more imaging sensors. The imaging sensors may be positioned in various portions of physical dining environment 140 for capturing images of physical dining environment 140 or portions thereof. For example, sensors 142a, 142b, and/or 142c may comprise imaging sensors configured to capture 2D and/or 3D images. In some aspects, the 2D and/or 3D cameras may comprise an existing camera (e.g., a security camera) configured to capture images of users within the physical dining environment 140. In such aspects, the imaging sensors may be used to identify, detect, and/or determine a count of occupants or patrons in the physical dining environment 140. For example, the imaging sensors provide a computer vision for determining or outputting a number of people in the physical dining environment 140. In some aspects, imaging sensors may comprise infrared sensors that count persons at locations (e.g., chairs, seats, tables, entry/exits, etc.) of physical dining environment 140.

Additionally, or alternatively, the one or more sensors (e.g., sensors 142a, 142b, and/or 142c) may comprise one or more heat sensors. In such aspects, the one or more sensors may comprise thermal cameras or heat cameras to calculate a density of occupancy within physical dining environment 140 to translate into a number of people. Additionally, or alternatively, the heat sensors may define, for one or more occupants, a thermal outline of an occupant, where the number of thermal outlines within the physical dining environment 140 can be used to detect occupants at specific locations (e.g., locations 144a-144e) within physical dining environment 140, and, upon which a count of occupants can be determined.

Additionally, or alternatively, the one or more sensors may comprise one or more signal sensors, e.g., signal sensor 148. In various aspects, a signal sensor may comprise can scan for wireless activity (e.g., wireless signals sent according to the BLUETOOTH standard and/or WWI standard) in an area to detect devices such as laptops, cell phones, wearables and other mobile and/or wireless devices (e.g., user computing device 111c1). In one example, a signal sensor may be a OCCUSPACE sensor that translates a signal count into a device count that may be used to determine, extrapolate, or otherwise identify a number of occupants in a given area, e.g., in physical dining environment 140.

In various aspects, the sensor data corresponds to one or more locations (e.g., one or more locations of dining areas (e.g., seats, etc.) within the physical dining environment. Such locations may comprise, for example, one or more locations 144a, 144b, 144c, 144d, and/or 144e. The locations may chairs, seats, bar areas, standing locations, or the like.

With reference to FIG. 3, at block 304, method 300 comprises inputting, into an AI model (e.g., AI model 107) executing on the one or more processors, the sensor data. In various aspects AI model 107 is trained with sensor data captured by the one or more sensors positioned within the physical dining environment 140.

AI model 107 may be trained on sensor data as described herein. For example, in various aspects AI model 107 comprises a convolutional neural network (CNN) for inputting and/or analyzing image based sensor data from camera based sensors, e.g., sensors 142a, 142b, and/or 142c.

Additionally, or alternatively, AI model 107 may be trained with additional information or data, including non-sensor data. Such non-sensor data may include, by way of non-limiting example, timing data. That is, in some aspects, AI model 107 may be further trained with timing data. Generating a prediction, as describe herein, may comprise inputting a time value for the prediction. In such aspects, the prediction may define the utilization value for the physical dining environment 140 at the time value. In such aspects, a prediction and/or utilization value, or related information, can be displayed on a GUI (GUI 402 as described herein for FIG. 4) with timing information (e.g., when the prediction and/or utilization value was made), where the prediction and/or utilization value, or related information, can be sent as a notification to users via a mobile device (e.g., user computing device 111c1), e.g., including for when prices have dipped, in order to encourage customers to visit physical dining environment 140.

Additionally, or alternatively, AI model 107 may be trained with additional non-sensor data, which may include weather data (e.g., weather may affect occupants or foot traffic within physical dining environment 140). Additionally, or alternatively, AI model 107 may be trained with event data including, for example, local event data defining or indicating local events in the area of the physical dining environment 140 that may impact a number of occupants and/or otherwise foot traffic within the physical dining environment 140. Additionally, or alternatively, AI model 107 may be trained with data including traffic data (e.g., vehicular traffic data) that may impact a number of occupants and/or otherwise foot traffic within the physical dining environment 140, where more traffic may indicate additional foot traffic within physical dining environment 140.

Additionally, or alternatively, AI model 107 may be trained with data including data defining a number of tables or seats (e.g., locations 144a, 144b, 144c, 144d, and/or 144e) within the physical dining environment 140. The number of seats, locations, etc. can be used to determine value of a food item or other item of physical dining environment 140, for example, at a given time based on occupancy of physical dining environment 140.

Additionally, or alternatively, AI model 107 may be trained with data including non-sensor based occupancy data defining occupancy within the physical dining environment 140. Such data may comprise, by non-limiting example, data from existing point-of-sale (POS) systems and/or table reservation systems that have the capacity to output a current occupancy of a physical dining environment 140. Such systems may collect or source data via manual entry by employees regarding specific seats or tables that are available or occupied, etc.

Additionally, or alternatively, AI model 107 may be trained with data including one or more meal duration times. For example, AI model 107 can be trained based on average meal durations to output a prediction regarding minimized turnaround time from seating one group of customer to a next group. The prediction can be used to determine reservation availability and/or food item price based on expected utilization of a given table and/or seat.

Additionally, or alternatively, AI model 107 may be trained with data including customer-specific data. Such data may include, for example, customer-specific data may comprise individual consumer data, such as loyalty data or behavior data. For example, such data may comprise a number of visits to physical dining environment 140 and data with respect to other customers or patrons, and the likelihood of a specific customer to become a patron of the physical dining environment 140 after a certain number of visits. Such data may be used to train AI model 107 to offer reduced value food items and/or preferred seat locations if, for example, the user is expected to be likely to become a repeat customer or visitor.

Additionally, or alternatively, AI model 107 may be trained with data including a type of location, such as a type of table or seat within the physical dining environment 140. The type of location may be specific to allocation, e.g., by server(s) 102 and/or mobile app 108, a certain value (e.g., pricing amount) and/or utilization within the physical dining environment 140.

Additionally, or alternatively, AI model 107 may be trained with data including historical transactions made by customers of the physical dining environment. For example, such historical transaction may comprise historical sales of food and/or drinks.

Additionally, or alternatively, AI model 107 may be trained with data including infrastructure related data of the physical dining environment 140. This additional information can be used to determine a real-time capacity of physical dining environment 140. For example, in some aspects, capacity or utilization may not only be defined by a number of seats in a restaurant, but also based on capacity or utilization of infrastructure, such as infrastructure 149. By way of non-limiting example, infrastructure 149 (such as a grill) may have a certain capacity or utilization. In one example, if infrastructure 149 is full and backed up for a given time (e.g., a next hour), then grilled food items be increased in value by server(s) 102 as a result. As another example, if a pickup counter is backed up but delivery cars are available, a pricing value may be adjusted by server(s) 102 for various revenue streams, including operators associated with physical dining environment 140 including, but not limited to operators associated with dine-in, takeout (pickup), and/or delivery. Training on such data allows AI model 107 to apply dynamic pricing algorithm by outputting predictions and/or utilization values to allow for dynamic values for pricing food items, drinks, menus, and/or other assets associated with physical dining environment 140. The dynamic pricing algorithm can comprise increasing a value of food item during high utilization of physical dining environment 140 or related infrastructure, and vice versa.

More generally, in various aspects, AI model 107 may comprise an artificial intelligence (AI) based model trained with at least one AI algorithm. Training of the AI model 107 involves analysis of sensor data (e.g., as collected and/or captured by the sensor(s) described herein) to configure weights of the AI model 107, and its underlying algorithm (e.g., machine learning or artificial intelligence algorithm) used to predict utilization value(s) associated with physical dining environment 140. For example, in various aspects herein, generation of the AI model 107 involves training the AI model 107 with sensor data such as described herein. In some aspects, one or more processors of a server or a cloud-based computing platform (e.g., IoT server(s) 102) may receive sensor data via a computer network (e.g., computer network 120). In such aspects, the server and/or the cloud-based computing platform may train the AI model 107 with the LiDAR data, ToF data, and/or pixel data, heat data, pressure data, and/or signal data as captured and collected by the sensor(s) positioned with physical dining environment 140.

In various aspects, a machine learning imaging model, as described herein (e.g. AI model 107), may be trained using a supervised or unsupervised machine learning program or algorithm. The machine learning program or algorithm may employ a neural network, which may be a convolutional neural network, a deep learning neural network, or a combined learning module or program that learns in two or more features or feature datasets (e.g., pixel data, heat data, pressure data, signal data) in a particular areas of interest. The machine learning programs or algorithms may also include automatic reasoning, regression analysis, support vector machine (SVM) analysis, decision tree analysis, random forest analysis, K-Nearest neighbor analysis, naïve B ayes analysis, clustering, reinforcement learning, and/or other machine learning algorithms and/or techniques. In some aspects, the artificial intelligence and/or machine learning based algorithms may be included as a library or package executed on IoT server(s) 102. For example, libraries may include the TENSORFLOW based library, the PYTORCH library, and/or the SCIKIT-LEARN Python library.

Machine learning may involve identifying and recognizing patterns in existing data, such as identifying in order to facilitate making predictions or identification for subsequent data (such as using the AI model 107) to output a prediction of a specific number or count of individuals in a physical dining environment 140 and/or otherwise output a utilization value of physical dining environment 140 based on the sensor data).

Machine learning model(s), such as the AI model 107 described herein for some aspects, may be created and trained based upon example data (e.g., “training data” and related pixel data, LiDAR data, and/or ToF data, heat data, signal data, pressure data) as inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on a server, computing device, or otherwise processor(s) as described herein, to predict or classify, based on the discovered rules, relationships, or model, an expected output, score, or value, e.g., such as predictions and/or utilization values of physical dining environment 140.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

Supervised learning and/or unsupervised machine learning may also comprise retraining, relearning, or otherwise updating models with new, or different, information, which may include information received, ingested, generated, or otherwise used over time. The disclosures herein may use one or both of such supervised or unsupervised machine learning techniques.

With reference to FIG. 3, at block 306, method 300 comprises generating, by the AI model and based on the sensor data, a prediction defining a utilization value of the physical dining environment. In some aspects, the prediction may comprise a ratio for a restaurant to price its services. In some aspects, the prediction defines a ratio that allows for dynamic valuation or pricing of its services (e.g., including but not limited to reservations and food/drink orders) based upon utilization of physical dining environment 140 and/or time, location, or other data (e.g., non-sensor data) as described herein. For example, a value of “0.8,” on a 0-1 scale, may be output when sensor data (e.g., as provided by sensors described herein) indicates high utilization where there is a corresponding high number of occupants within physical dining environment 140. Similarly, a value of “0.2” may be output when sensor data (e.g., as provided by sensors described herein) indicates low utilization where there is a corresponding low number of occupants within physical dining environment 140. It is to be understood that other values and scales may be used as output for the prediction.

In various aspects, a utilization value may be generated in real time or near-real time. Additionally, or alternatively, an indication of the utilization value is displayed on a graphic user interface (GUI) (e.g., GUI 402 of FIG. 4) on periodic basis.

In some aspects, the prediction may correspond to a specific location within the physical dining environment. For example, the specific location may comprise a specific seat within the physical dining environment 140. In such aspects, location is can be granular, and define a specific location within the physical dining environment 140. The location can comprise precise coordinates that defines a point, seat, bar area, or otherwise position within the physical dining environment 140 or portion thereof (e.g., portion of the physical dining environment 140p). Such precise locations allow for digital mapping the physical dining environment 140 and/or detecting occupancy (or lack thereof) of locations (e.g., locations 144a-114c) of physical dining environment 140.

In additional aspects, sensor data (e.g., as collected from any of the one or more sensors described herein) may corresponds to a portion of the physical dining environment (e.g., portion of the physical dining environment 140p). In such aspects, the prediction for the overall physical dining environment 140 may define a utilization of the physical dining environment 140 as an extrapolated prediction based on the portion of the physical dining environment 140. For example, if a portion of the physical dining environment 140p is known to be a popular seating area, then it may define whether the physical dining environment 140, as a whole, is highly utilized if it is completely full of occupants, compared to less utilized if it is only partially full of occupants.

FIG. 4 illustrates an example user interface as rendered on a display screen 400 of a user computing device (e.g., user computing device 111c1) in accordance with various aspects disclosed herein. For example, as shown in the example of FIG. 4, guided user interface (GUI) 402 may be implemented or rendered via an application (app executing on user computing device 111c1). For example, as shown in the example of FIG. 4, GUI 402 may be implemented or rendered via a native app executing on user computing device 111c1. In the example of FIG. 4, user computing device 111c1 is a user computer device as described for FIG. 1, e.g., where 111c1 is illustrated as an APPLE iPhone that implements the APPLE iOS operating system and that has display screen 400. User computing device 111c1 may execute one or more native applications (apps) on its operating system, including, for example, a mobile app (e.g., mobile app 108). Such native apps may be implemented or coded (e.g., as computing instructions) in a computing language (e.g., SWIFT) executable by the user computing device operating system (e.g., APPLE iOS) by the processor of user computing device 111c1. In various aspects, the mobile app (e.g., an mobile app 108) executing on a mobile devices, such as user computing device 111c1, may be referred to as an “CEATZ” app, designed to depict and display to a user with a prediction, utilization value, digital mapping or depiction of physical dining environment 140 having various locations, or otherwise as described herein.

Additionally, or alternatively, GUI 402 may be implemented or rendered via a web interface, such as via a web browser application, e.g., Safari and/or Google Chrome app(s), or other such web browser or the like.

In various aspects, the output, prediction, utilization value, or information and/or graphics derived therefrom, may be displayed on display screen 400 via GUI 402. For example, as shown, GUI 402 displays a portion of physical dining environment 140 and a description of physical dining environment 140, where in the example of FIG. 4, is provided as “Polpetti Meatball bar.”

GUI 402 also displays a digital mapping 405, or otherwise seating or location chart, of physical dining environment 140. Digital mapping 405 depicts graphic depictions of locations within physical dining environment 140 (e.g., including locations 144a-144e). Digital mapping 405 may have be defined by, or generated from, sensor data collected or captured for any of the sensor(s) described herein. Such sensor(s) are positioned so as to cover the corresponding real-world locations that the graphic depictions or otherwise locations of digital mapping 405.

In some aspects, a prediction and/or utilization value as determined or output by AI model 107 may be used to determine additional outputs (e.g., dynamic price(s), times, or other values) comprising a service provided by an operator of the physical dining environment 140. Such outputs may comprise, by way of non-limiting example, a value of a food item (e.g., food or drink) provided by the operator of the physical dining environment; a value of a reservation (e.g., a dining reservation) provided by an operator of the physical dining environment, and/or a dynamic menu offered by the operator of the physical dining environment. For example, a dynamic menu may be based on a utilization value of the physical dining environment 140, where the price of a given menu item may be based on the prediction and/or utilization value as output or determined by AI model 107.

Additionally, or alternatively, in some aspects the one or more outputs may comprise a ranged value, such a ranged value of prices and/or values of services or items provided by physical dining environment 140. For example, a value generated by AI model 107 can be expressed as a range of suggested prices (min-max), a fixed charge/discount for reservations ($15 booking fee, $5 off order), and/or a percentage increase or decrease in menu item pricing. For peak hours, a surplus charge may apply. To drive demand generation, offers below standard may be presented to customers within lower utilization time period.

With reference to FIG. 4, a value of a reservation 410 provided by an operator of the physical dining environment 410 is displayed on GUI 402. GUI 402 may further include a selectable user interface (UI) button 415 to allow the user select a reservation (e.g., reservation 410) which relates to a reservation shown for Apr. 9, 2021 (4:00 pm) at location 4A at a value of $100. In this way, a user can choose a dynamically valued reservation at a specific time and location associated with the physical dining environment 140 based on a current utilization and/or occupancy (or a predicted utilization and/or occupancy) of physical dining environment 140 as determined by the AI model 107 or otherwise as described herein.

### ADDITIONAL CONSIDERATIONS

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Aspects of the Disclosure

The below describe non-limiting aspects of the present disclosure.

1. An internet of things (IoT) sensor based method of improving utilization of a physical dining environment using artificial intelligence (AI), the IoT sensor based method comprising: collecting, by one or more processors, sensor data from one or more sensors positioned within the physical dining environment, wherein the sensor data corresponds to one or more locations within the physical dining environment; inputting, into an AI model executing on the one or more processors, the sensor data, wherein the AI model is trained with sensor data captured by the one or more sensors positioned within the physical dining environment; and generating, by the AI model and based on the sensor data, a prediction defining a utilization value of the physical dining environment.

2. The IoT sensor based method of aspect 1, wherein the AI model is further trained with timing data, wherein generating the prediction further comprises inputting a time value for the prediction, and wherein the prediction defines the utilization value for the physical dining environment at the time value.

3. The IoT sensor based method of any one of aspects 1-2, wherein the sensor data corresponds to a portion of the physical dining environment, and wherein the prediction defining the utilization of the physical dining environment is an extrapolated prediction based on the portion of the physical dining environment.

4. The IoT sensor based method of any one of aspects 1-3, wherein the AI model is further trained with one or more of: weather data, event data, traffic data, a number of tables or seats within the physical dining environment, non-sensor based occupancy data defining occupancy within the physical dining environment, one or more meal duration times, customer-specific data, a type of table or seat within the physical dining environment, and/or historical transactions made by customers of the physical dining environment.

5. The IoT sensor based method of any one of aspects 1-4, wherein the AI model is further trained with infrastructure related data of the physical dining environment.

6. The IoT sensor based method of any one of aspects 1-5, wherein the one or more sensors comprise one or more of: one or more pressure sensors, one or more imaging sensors, one or more heat sensors, and/or one or more signal sensors.

7. The IoT sensor based method of any one of aspects 1-6, wherein the one or more sensors comprising an existing camera configured to capture images of users within the physical dining environment.

8. The IoT sensor based method of any one of aspects 1-7, wherein the one or more locations areas of the physical dining environment comprise one or more of: a seat positioned within the physical dining environment, a table positioned within the physical dining environment, or a bar area positioned within the physical dining environment.

9. The IoT sensor based method of any one of aspects 1-8, wherein the prediction corresponds to a specific location within the physical dining environment.

10. The IoT sensor based method of any one of aspects 1-9 further comprising determining a one or more outputs based on the prediction, the one or more outputs comprising of at least one of: a service provided by an operator of the physical dining environment, a value of a food item provided by the operator of the physical dining environment, a value of a reservation provided by an operator of the physical dining environment, and/or a dynamic menu offered by the operator of the physical dining environment.

11. The IoT sensor based method of aspect 10, wherein the one or more outputs comprises a ranged value.

12. The IoT sensor based method of any one of aspects 1-11, wherein the utilization value is generated in real time or near-real time and/or wherein an indication of the utilization value is displayed on a graphic user interface (GUI) on periodic basis.

13. An internet of things (IoT) sensor based system configured to improve utilization of a physical dining environment using artificial intelligence (AI), the IoT sensor based system comprising: one or more sensors positioned within a physical dining environment; one or more processors communicatively coupled to the one or more sensors; one or more memories accessible by the one or more processors; and computing instructions stored on the one or more memories that, when executed, cause the one or more processors to: collect sensor data from the one or more sensors positioned within the physical dining environment, wherein the sensor data corresponds to one or more locations within the physical dining environment; input, into an AI model executing on the one or more processors, the sensor data, wherein the AI model is trained with sensor data captured by the one or more sensors positioned within the physical dining environment; and generate, by the AI model and based on the sensor data, a prediction defining a utilization value of the physical dining environment.

14. The IoT sensor based system of aspect 13, wherein the AI model is further trained with timing data, wherein generating the prediction further comprises inputting a time value for the prediction, and wherein the prediction defines the utilization value for the physical dining environment at the time value.

15. The IoT sensor based system of any one of aspects 13-14, wherein the sensor data corresponds to a portion of the physical dining environment, and wherein the prediction defining the utilization of the physical dining environment is an extrapolated prediction based on the portion of the physical dining environment.

16. The IoT sensor based system of any one of aspects 13-15, wherein the AI model is further trained with one or more of: weather data, event data, traffic data, a number of tables or seats within the physical dining environment, non-sensor based occupancy data defining occupancy within the physical dining environment, one or more meal duration times, customer-specific data, a type of table or seat within the physical dining environment, and/or historical transactions made by customers of the physical dining environment.

17. The IoT sensor based system of any one of aspects 13-16, wherein the AI model is further trained with infrastructure related data of the physical dining environment.

18. The IoT sensor based system of any one of aspects 13-17, wherein the one or more sensors comprise one or more of: one or more pressure sensors, one or more imaging sensors, one or more heat sensors, and/or one or more signal sensors.

19. The IoT sensor based system of any one of aspects 13-18, wherein the one or more sensors comprising an existing camera configured to capture images of users within the physical dining environment.

20. A tangible, non-transitory computer-readable medium storing instructions for improving utilization of a physical dining environment using artificial intelligence (AI) that when executed by one or more processors cause the one or more processors to: collect sensor data from one or more sensors positioned within the physical dining environment, wherein the sensor data corresponds to one or more locations within the physical dining environment; input, into an AI model executing on the one or more processors, the sensor data, wherein the AI model is trained with sensor data captured by the one or more sensors positioned within the physical dining environment; and generate, by the AI model and based on the sensor data, a prediction defining a utilization value of the physical dining environment.

What is claimed is:

1. An internet of things (IoT) sensor based method of improving utilization of a physical dining environment using artificial intelligence (AI), the IoT sensor based method comprising:
collecting, by one or more processors, sensor data from one or more sensors positioned within the physical dining environment, wherein the sensor data corresponds to one or more locations within the physical dining environment;
inputting, into an AI model executing on the one or more processors, the sensor data, wherein the AI model is trained with sensor data captured by the one or more sensors positioned within the physical dining environment; and
generating, by the AI model and based on the sensor data, a prediction defining a utilization value of the physical dining environment.

2. The IoT sensor based method of claim 1,
wherein the AI model is further trained with timing data,
wherein generating the prediction further comprises inputting a time value for the prediction, and
wherein the prediction defines the utilization value for the physical dining environment at the time value.

3. The IoT sensor based method of claim 1, wherein the sensor data corresponds to a portion of the physical dining environment, and wherein the prediction defining the utilization of the physical dining environment is an extrapolated prediction based on the portion of the physical dining environment.

4. The IoT sensor based method of claim 1, wherein the AI model is further trained with one or more of: weather data, event data, traffic data, a number of tables or seats within the physical dining environment, non-sensor based occupancy data defining occupancy within the physical dining environment, one or more meal duration times, customer-specific data, a type of table or seat within the physical dining environment, and/or historical transactions made by customers of the physical dining environment.

5. The IoT sensor based method of claim 1, wherein the AI model is further trained with infrastructure related data of the physical dining environment.

6. The IoT sensor based method of claim 1, wherein the one or more sensors comprise one or more of: one or more pressure sensors, one or more imaging sensors, one or more heat sensors, and/or one or more signal sensors

7. The IoT sensor based method of claim 1, wherein the one or more sensors comprising an existing camera configured to capture images of users within the physical dining environment.

8. The IoT sensor based method of claim 1, wherein the one or more locations areas of the physical dining environment comprise one or more of: a seat positioned within the physical dining environment, a table positioned within the physical dining environment, or a bar area positioned within the physical dining environment.

9. The IoT sensor based method of claim 1, wherein the prediction corresponds to a specific location within the physical dining environment.

10. The IoT sensor based method of claim 1 further comprising determining a one or more outputs based on the prediction, the one or more outputs comprising of at least one of: a service provided by an operator of the physical dining environment, a value of a food item provided by the operator of the physical dining environment, a value of a reservation provided by an operator of the physical dining environment, and/or a dynamic menu offered by the operator of the physical dining environment.

11. The IoT sensor based method of claim 10, wherein the one or more outputs comprises a ranged value.

12. The IoT sensor based method of claim 1, wherein the utilization value is generated in real time or near-real time and/or wherein an indication of the utilization value is displayed on a graphic user interface (GUI) on periodic basis.

13. An internet of things (IoT) sensor based system configured to improve utilization of a physical dining environment using artificial intelligence (AI), the IoT sensor based system comprising:
one or more sensors positioned within a physical dining environment;
one or more processors communicatively coupled to the one or more sensors;
one or more memories accessible by the one or more processors; and
computing instructions stored on the one or more memories that, when executed, cause the one or more processors to:
collect sensor data from the one or more sensors positioned within the physical dining environment, wherein the sensor data corresponds to one or more locations within the physical dining environment;
input, into an AI model executing on the one or more processors, the sensor data, wherein the AI model is trained with sensor data captured by the one or more sensors positioned within the physical dining environment; and
generate, by the AI model and based on the sensor data, a prediction defining a utilization value of the physical dining environment.

14. The IoT sensor based system of claim 13,
wherein the AI model is further trained with timing data,
wherein generating the prediction further comprises inputting a time value for the prediction, and
wherein the prediction defines the utilization value for the physical dining environment at the time value.

15. The IoT sensor based system of claim 13, wherein the sensor data corresponds to a portion of the physical dining environment, and wherein the prediction defining the utilization of the physical dining environment is an extrapolated prediction based on the portion of the physical dining environment.

16. The IoT sensor based system of claim 13, wherein the AI model is further trained with one or more of: weather data, event data, traffic data, a number of tables or seats within the physical dining environment, non-sensor based occupancy data defining occupancy within the physical dining environment, one or more meal duration times, customer-specific data, a type of table or seat within the physical dining environment, and/or historical transactions made by customers of the physical dining environment.

17. The IoT sensor based system of claim 13, wherein the AI model is further trained with infrastructure related data of the physical dining environment.

18. The IoT sensor based system of claim 13, wherein the one or more sensors comprise one or more of: one or more pressure sensors, one or more imaging sensors, one or more heat sensors, and/or one or more signal sensors

19. The IoT sensor based system of claim 13, wherein the one or more sensors comprising an existing camera configured to capture images of users within the physical dining environment.

20. A tangible, non-transitory computer-readable medium storing instructions for improving utilization of a physical dining environment using artificial intelligence (AI) that when executed by one or more processors cause the one or more processors to: collect sensor data from one or more sensors positioned within the physical dining environment, wherein the sensor data corresponds to one or more locations within the physical dining environment;
input, into an AI model executing on the one or more processors, the sensor data, wherein the AI model is trained with sensor data captured by the one or more sensors positioned within the physical dining environment; and
generate, by the AI model and based on the sensor data, a prediction defining a utilization value of the physical dining environment.
